(19) United States
(12) Patent Application Publication
(10) Pub. No.: US 2016/0019741 A1
(43) Pub. Date: Jan. 21, 2016

(54) Networked High Availability and Redundancy Among Vending Devices

(71) Applicant: International Business Machines Corportation, Armonk, NY (US)

(72) Inventors: Saurabh Dua, Durham, NC (US); Mario Alessandro Maldari, Longmont, CO (US); Paul Anthony Smith, Cary, NC (US); Jarett Stein, Bryn Mawr, PA (US); Sahdevsinh P. Zala, Cary, NC (US)

(21) Appl. No.: 14/332,045

(22) Filed: Jul. 15, 2014

(51) Int. Cl. G07F 11/00

(52) U.S. Cl. CPC G07F 11/002

(57) ABSTRACT

When a first vending machine fails to dispense a purchased item to a consumer, the first vending machine requests a fail-over vending machine designation and transfer of credit to the fail-over vending machine. A server receives the request, finds a candidate vending machine in proximity to the first vending machine which also has the item in stock, creates a credit token, and places the item on hold at the second vending machine.

### FIELD OF THE INVENTION

This invention is related to systems, methods and computer program products for networking vending machines in order to provide fail-over service to a customer when a first vending machine malfunctions and a second vending machine can provide the same item or product.

### BACKGROUND OF INVENTION

There are reportedly over 4.6 million vending machines in operation in the United States, with an average annual per capita expenditure of $27.00 according to the web site Statistic Brain. Vending machines provide around-the-clock access to food, beverages, video rentals, and even electronics and healthcare products in locations such as business buildings, hospitals, dormitories, hotels, airports, train stations, prisons, schools, and highway rest areas. Some vending machines even provide low-level manufacturing on demand, such as cutting of duplicate keys, engraving of pet and luggage tags, and manufacturing some plastic items such as souvenirs. As additive manufacturing technologies such as so-called 3-D printers come into the mainstream retail space, it is conceivable that a user will be able to browse a library of possible items to be manufactured, then to select and pay for an item, followed by the item being produced on demand.

Vending machines are often considered a secondary or even last resort option of food source. Unfortunately, many vending machines are unreliable, undependable, and error prone. Users often insert money only to find the product is not properly dispensed, or that exact change is required, that the return money mechanism does not work, or that the product is dispensed but the change (difference in deposit and price) is not given. Product handling mechanisms are unreliable because of the wide variety of product packaging, shapes and weights (bags, boxes, conformant wraps, etc.), and physical coin and bill handling mechanisms can be unreliable due to the variety of money types and conditions (worn and torn paper, stains and inks on paper, bent coins, counterfeits and slugs, etc.). Complicate these factors with the environmental conditions under which many machines operate, such as unattended operation in outdoor areas where they are subject to weather conditions as well as human tampering, and vending machines ultimately end up to be quite unpredictable in their condition and operation.

When a user experiences a failure such as product not dispensing or change not being given, the user is typically out of options. First, the user may or may not have any additional money to use to try again. Even if they have more money, it seems like a risky proposition to put more money in a malfunctioning machine. Obtaining a refund is usually next to impossible, especially not quickly. If the product snags or hangs during dispensing, one has the option to bang on the machine, to rock or tilt the vending machine, or to try to reach up into the machine to grab the product. All of these can further damage the machine, and can lead to injury or even death when the machine tips over onto the customer.

Another option is to abandon this purchase, forfeit the money deposited, and go to another vending machine, but knowing the location of the next closest machine is difficult. If the customer has no more physical money (e.g., coins, bills, tokens), then this is not an option.

While one would think that this very common experience would have been addressed in the art by now, it has not. Perhaps this is because the loss is small—usually less than $2.00 per failed transaction—so complaints to authorities are practically non-existent, and if they were made, authorities would not be compelled to investigate such a small loss. Because the consumer's expectation of vending machine reliability is relatively low, customers almost implicitly are agreeing to a gamble when they choose to try to use a vending machine, so complaints are far and few between.

### SUMMARY OF THE EMBODIMENTS OF THE INVENTION

When a first vending machine fails to dispense a purchased item to a consumer, the first vending machine requests a fail-over vending machine designation and transfer of credit to the fail-over vending machine. A server receives the request, finds a candidate fail-over vending in proximity to the first vending machine which also has the item in stock, creates a credit token, and optionally places the item on hold at the second vending machine for retrieval by the consumer.

### BRIEF DESCRIPTION OF THE DRAWINGS

The figures presented herein, when considered in light of this description, form a complete disclosure of one or more embodiments of the invention, wherein like reference numbers in the figures represent similar or same elements or steps.

FIG. 1 illustrates an arrangement of system components according to one embodiment.

FIG. 2 sets forth exemplary embodiments for cooperation between a first vending machine which fails to deliver an item and a credit server.

FIG. 3 sets forth exemplary embodiments for cooperation between a second vending machine which is co-opted to deliver an item and a credit server.

FIG. 4 illustrates a generalized computing platform suitable for combination with program instructions to perform the logical processes shown and described herein.

### DETAILED DESCRIPTION OF EMBODIMENT(S) OF THE INVENTION

### Problems Recognized

While some advanced vending machines provide more convenience for a user, such as using a web browser to pay for and reserve a copy of a particular movie disk on a particular vending machine, or such as using a credit card or debit card to pay for an item instead of bills or coins, the basic mechanisms for vending the product are still prone to failure. For example, one major supplier of video and game disk rental vending machines requires a user to call a toll-free telephone number to ask for a refund or credit if a machine fails to dispense a product or fails to ingest (return) a product and place it back in inventory.

So, although reportedly adding a credit card reader and data interface reportedly only costs a few hundred dollars per machine and that cost is recovered by a project increase of 20%-30% in annual sales revenue over vending machines without a credit card reader, the process of dealing with a vending failure for dispensing and ingesting products remains largely unsolved.

We therefore set out to design a fail-over mechanism to add some redundancy between similar vending machines (or vending machines offering similar product), and to leverage their data network interfaces (or new ones) to allow vending machines to be more reliable and user friendly. It is expected by the inventors that such improvements would ultimately generate more revenue for the vending machines and their owners, while creating a less frustrating experience for the consumer and engendering brand loyalty to the improved systems.

### Terminology and Technology

In the following description of inventive processes, apparatuses, and computer program products, certain standard and proprietary technologies may be incorporated, coordinated and otherwise combined to yield some of the functionality according to the invention.

Data network interfaces between vending machines, servers, and customers and customers' devices may include but are not limited to short range wireless interfaces (RFID, Wi-Fi, Bluetooth™, Zigbee™, IrDA, etc.), and wired interfaces (ethernet, dial-up modems, etc.). Protocols used may include encrypted and unencrypted protocols, including but not limited to OnLine Transaction Protocol (OLTP), Transmission Control Protocol (TCP), Internet Protocol (IP), Data EXchange Uniform Code Standard (DEX and DEX/UCS), and e-Port.

Embodiments may use any individual or a combination of these data network interfaces and protocols, in addition to proprietary data interfaces and proprietary protocols.

### Overview of the Embodiments

The one or more embodiments include a plurality of vending machines which are networked for high availability to consumers. This network of vending machines would serve as an inventory for a series of machines, and it would also provide for a more reliable experience due to a new ability to shift functionality from a first failed vending machine to a second, operational vending machine. The fail-over process includes automatically transferring credit for a failed item vending transaction from a first vending machine where the failure occurred to a second vending machine which is known to have the same item in stock and available, sorted by proximity to the first vending machine. Elements of inventory control unified over a set of vending machines, mapping and location technologies, and a variety of innovative credit transfer methods are incorporated to yield an embodiment.

For example, consider the all-too-familiar case of a consumer inserting money into a vending machine and pressing the buttons to make an item selection, followed by the dispensing device failing to rotate sufficiently, resulting in the product getting stuck in the machine. According to one embodiment, the networked machines would have one or more sensors to detect completion of the vend cycle (e.g. successful dispensing of the selected item). If the one or more sensors did not detect successful vending completion, then a credit would be issued in one of several manners described in the following paragraphs, and an inventory search of nearby related vending machines would be performed. If the selected item is available at a nearby networked vending machine, the consumer is issued the credit, provided directions to the nearby vending machine, and the nearby (fail-over) vending machine is notified of the credit due to the consumer. Upon arriving at the fail-over vending machine, the consumer activates his or credit, and the item is automatically dispensed after validating the credit by the second vending machine.

### Dispensing Success/Failure Detection

There are a number of sensor arrangements which may be used individually or in combination to enable a vending machine to determine if a dispensing cycle was successful or not.

“Electric Eye”. One detection approach is to provide one or more photo-electric transmitter-receiver pairs in a pathway through which the item must travel, such as a gravity-fed falling path, to reach the bin from which the consumer may retrieve the item. If the photo-electric pair does not sense a break in the optical path between the pair, then it can be presumed by the logic of the enhanced vending machine that the item did not vend successfully. Perhaps it hung at the shelf level, or it is not in inventory and the machine's inventory tracking has failed.

Weight Scale. Another method of detecting a successful or failed vend cycle is to provide a weight scale in the consumer output bin, such that the known or expected weight of each item stocked in the vending machine is compared to a change in detected weight in the bin from a nominal (unloaded) weight to a loaded weight, where the change should be approximately equal to the expected weight of the dispensed item. If such a change in weight is not detected within a pre-determined period of time after the dispensing mechanism is activated, it can be presumed that the dispensing cycle failed.

Image Processing. Still another method of detecting a successful or failed vend cycle is to use image processing coupled with one or more digital cameras positioned and mounted in the vending machine to have a field of view over the stocking area, the output bin area, or both. By employing still frame image analysis or video analysis by the logic of the enhanced vending machine, it can be determined if a product or item actually exited the storage area or shelf, and whether or not it appeared in the output bin, and potentially whether or not a human hand is visible in the field of view retrieving the item. This detection method may be especially useful for vending machines of higher value items, such as electronics and electronic accessories in airports and train stations.

### Credit Issuance

Responsive to detection of a failed dispensing operation (or lack of detection of a successful dispensing operation), the enhanced vending machine would then generate and issue a credit to the consumer for the item. There are several methods of issuing a credit according to the present invention, which may be employed individually or in combination in various embodiments. For the purposes of this disclosure, we will refer to issuing of a credit to a consumer synonymously with issuing a credit to a user account. This however shall not imply that the consumer must establish a user account to use an embodiment, it merely recognizes that a user account in computing can consist of as little as one entry (the credit) for as short of a duration as one transaction (the fail-over cycle).

Code Issuance. The vending machine or a server to which it is communicably networked may generate a one-time-use numeric, alphabetic, or alpha-numeric code or token value for the failed transaction, which is then associated in a credit database by a server for the item. This code, or a human-readable value associated with it, is then displayed or spoken to the consumer at the first vending machine where the vend failure occurred. The user can remember or write down the code, and then take that to the alternative vending site in a manner described in the following paragraphs. To enhance the ability to remember the human-readable value associated with the code, it may be a word or phrase drawn from a dictionary of easy-to-remember codes. Alternatively, the consumer may be given the option to select or enter a code of his or her choice.

Mobile Telephone Association. The system may also issue a credit by allowing the user to enter his or her mobile phone number as a user-selected code. Then, a number of alternative processes may be employed individually or in combination. The system may send a code, such as an alpha-numeric string or an optical code (QR, bar code, picture, etc.), to the consumer's telephone to associate a credit with the device. Similarly, instead of entering a telephone number, the consumer may be provided an opportunity to enter another unique identifier value such as an email address or social network user name or handle, and this value may be associated with the credit in the credit database.

Facial Token. In another variation of issuing a credit to the consumer, the vending machine may be provided with an outward-facing digital camera for capturing an image of the consumer's face. This image is transmitted to a server where it is analyzed for markers, lands and characteristics for facial recognition. This profile resulting from the facial analysis is associated with the credit in the credit database for later use in authenticating the consumer at the second (fail-over) vending machine.

### Fail-Over Vending Machined Identification and Co-Opting

There are several processes within various embodiments in which a second vending machine may be identified as a fail-over vending machine to the first failed vending machine, and a credit transferred to the second vending machine. These processes may be used individually or in combinations.

Identification of Fail-Over Vending Machine. In order to identify a nearby second vending machine with the same item in stock, each vending machine may periodically transmit their stock status to a server which maintains a comprehensive stock inventory associated with locations of each vending machine. Another method is for the server, upon notification of a need to find an item in a nearby vending machine, to receive a message from the first vending machine regarding the failed vend cycle, determine the location of the first vending machine, find a first nearby (closest) vending machine, and query the first nearby vending machine for its inventory status of that item. Responsive to a positive query from the first nearby vending machine, it may be selected as the fail-over vending machine, otherwise, the server may find a second-closest vending machine and query its inventory status for the item. Eventually, a vending machine would be found with the item in stock, or the consumer would be given instructions on how to proceed to obtain a refund.

Yet another method would be to provide the consumer an alternative to select his or her secondary vending location so that the consumer can consider a planned route home, to work, etc.

Co-Opting the Selected Second Vending Machine. In one exemplary embodiment, once the secondary vending machine with the desired item in stock has been identified and selected, it is transmitted a message to hold that item in stock until the consumer comes to retrieve it (or until a pre-determined period of time has expired such as one hour or one day). This would prevent a very frustrating situation in which the consumer travels to the second location only to discover that the last of that item has been sold since his or her credit was issued. However, this feature is an option to disclosed embodiments.

The credit is transferred to the selected second vending machine in one or more of the following methods. First, it can be “pushed” to the second vending machine by transmitting information regarding the credit token issued to the consumer as described in the foregoing paragraphs (e.g., alpha-numeric code, QR code, image, telephone number, email address, social networking handle, etc.). The user would, in these embodiments, be provided with a user interface to input his or her token. This user interface may include one or more of a keypad, keyboard, microphone (with voice recognition function), bar code scanner or camera. This input credit code would then be compared locally to a previously-received credit code for the item, or it could be transmitted to a server for validation against the associated credit stored in the credit database for authentication.

In the foregoing embodiment employing facial recognition, upon arrival to the second vending machine and operation of a “retrieve credit” button, the second vending machine would capture a digital image of the consumer's face and transmit it to a facial recognition server which would authenticate the consumer against the stored credit in the credit database.

Responsive to the authentication of the credit using one or more of these methods, the second vending machine would vend the item, and preferably detect successful completion of the dispensing cycle. If dispensing fails, then the process may be repeated. If dispensing is successful, then preferably the second vending machine communicates with the server to have the credit deleted from the credit database.

### Customer Relationship Option

In an enhanced embodiment, the system of networked vending machines and server(s) may use some or all of the information regarding the consumer to improve the relationship with the consumer who has experienced the failure. For example, if the user identified himself or herself with a value such as an email address, telephone number, or social networking handle, the system may generate an apology message to that destination in order to repair the lost affinity with the consumer. To further improve the affinity of the consumer with the vending system, the system may offer a future bargain such as a coupon or even a free credit for an item, storing that credit in the credit database so that the consumer may use the same processes to retrieve a free or discounted item from a networked vending machine.

### Exemplary System Diagram

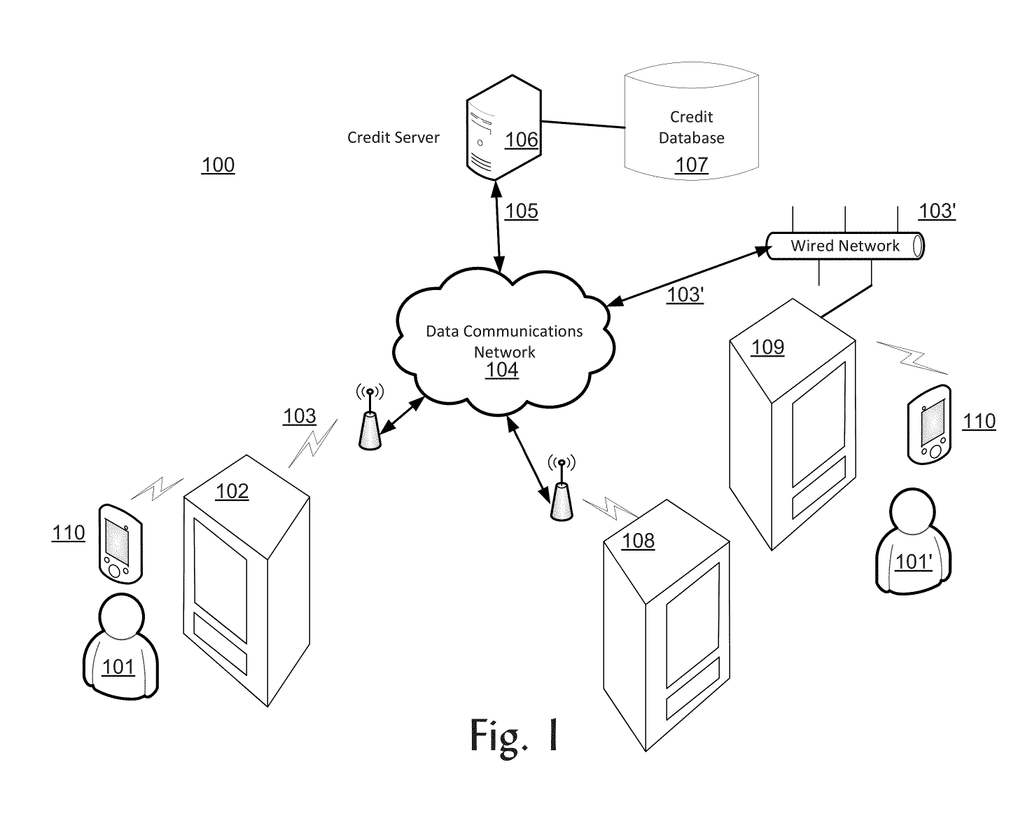

Referring now to FIG. 1, an exemplary arrangement (100) of components of a system according to at least one embodiment is shown. A consumer (101) present at a first vending machine (102) attempts to make a purchase in which the dispensing cycle fails, as previously discussed in the foregoing paragraphs. Wireless (103) or wired (103′) communications between the first vending machine (103) and a credit server (106) via a data communications network (104, 105) such as the Internet or a cellular telephone network using a protocol such as OLTP or DEX/UCS notifies the credit server of a need to find a fail-over vending machine and to issue a credit to the consumer (101).

The credit server (106) then searches for and finds a secondary vending machine (109) close to the consumer's (101) current position which currently has the item the consumer attempted to purchase in inventory, eliminating from the search vending machines (108) which do not currently have the item in stock. The credit server (106) creates a credit token (code, picture, alpha-string, face recognition profile, etc.) or receives a user-selected code from the consumer (101), and associates that credit token with the consumer and with the item in inventory in the second vending machine (109). Preferably, the credit server (106) also commands via the data communications network (105, 104, 103′) the second vending machine (109) to reserve and hold the item for the consumer for a period of time.

The credit server (106) then notifies the user (101) via the data communications network (105, 104, 103) optionally on a user interface of the first vending machine (102) or on a user interface of a consumer's mobile device (110) such as a cellular telephone or tablet computer of the location of the second vending machine (e.g., street address, driving instructions, walking instructions, etc.), and provides the credit code for the credit token to the user (if it was not user-selected). Optionally, the consumer may accept the offer or decline, the latter of which resulting in the credit server commanding the second vending machine to release the hold on the item.

Then, the user travels to the second vending machine (109) and the credit code or token is authenticated (e.g., code is entered, face is recognized, etc., and validated against the credit database (107)). Responsive to authentication of the credit, the second vending machine (109) vends the item to the consumer. Upon successful detection of dispensing the item, the second vending machine notifies the credit server of success, and the credit is deleted from the credit database (107).

Optionally, a consumer identifier (email address, social network handle, etc.) may be used in the future to offer the user a coupon or credit towards another item or service in order to repair any affinity lost in the inconvenience of the failed vending transaction.

### Exemplary Logical Processes

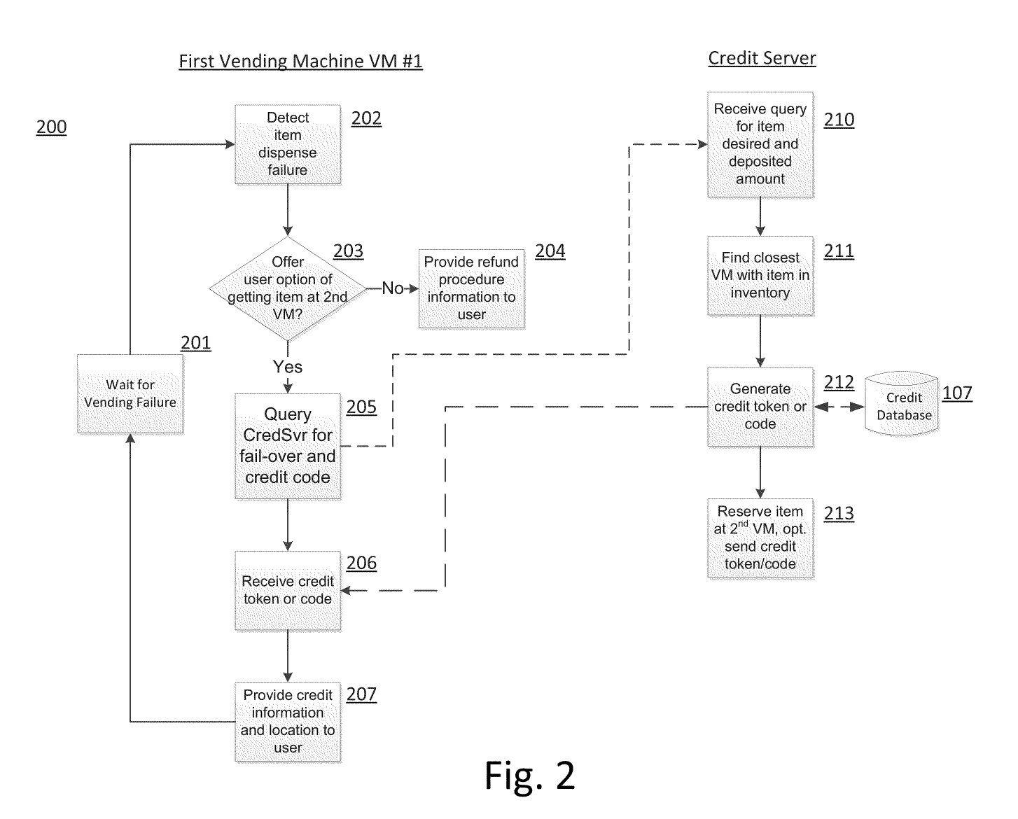

Turning to FIG. 2, exemplary logical processes (200) for a first vending machine (VM #1) and a credit server to cooperate to find a fail-over vending machine and issue a transferrable credit to a consumer are shown.

While vending (201), when a dispensing failure is detected (202), or alternatively an ingesting failure is detected in the case of a vending machine receiving a returned item such as a movie disk, the consumer is offered (203) the option to be issued a transferrable credit to a nearby machine (if available). If the user declines (204), the user is preferably provided instructions for how to obtain a refund, and optionally, the item and price information is transmitted to a refund server (which may optionally be the same as the credit server).

If the user accepts the offer, then the first vending machine queries (205) the credit server, which receives the query (210), and proceeds to find (211) the item in stock at a close or nearby second vending machine (VM #2). Once the item is found, a transferrable credit is generated and recorded in the credit database (107), and the code is transmitted (or facial recognition profile recorded) to the first vending machine (206), where it is provided to the consumer (207) or to the consumer's mobile device (cell phone, tablet computer, etc.).

The credit server also optionally commands the second vending machine to reserve or hold (213) from inventory the item for a period of time.

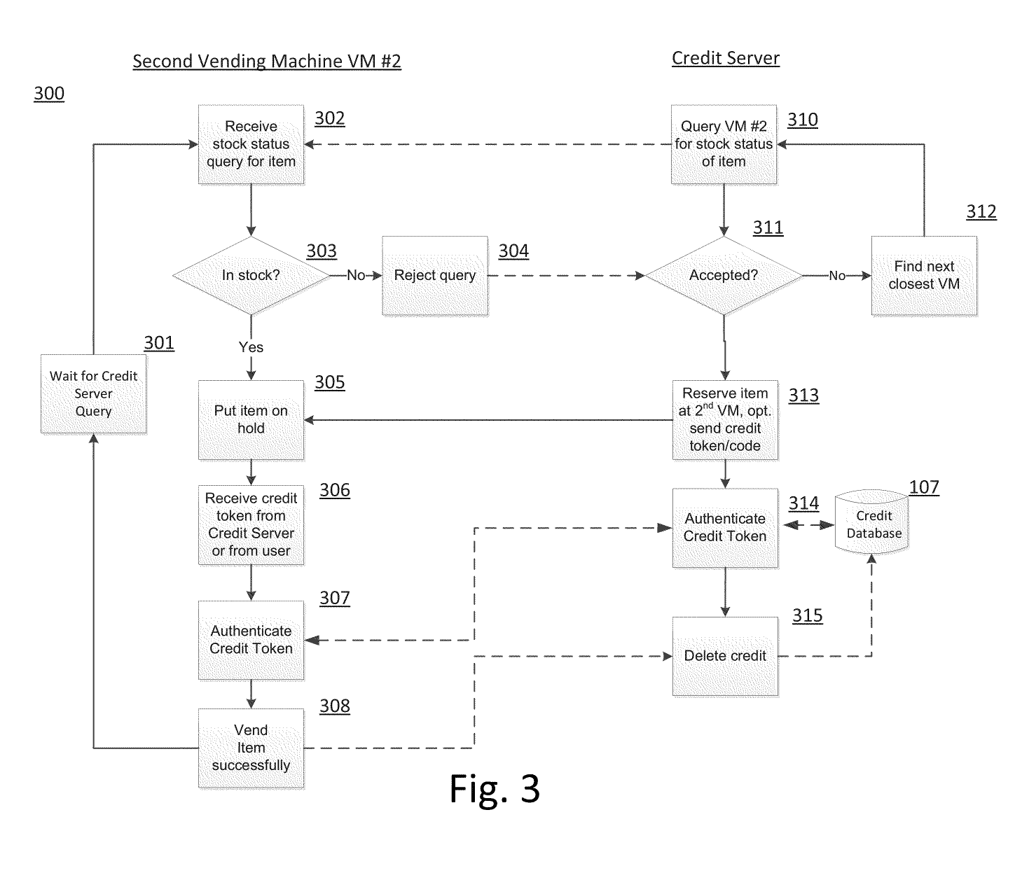

Turning now to FIG. 3, exemplary logical processes (300) for a second vending machine (VM #2) and the credit server to cooperate according to at least one embodiment are shown. While vending normally (301), the second vending machine receives (302) a stock status query from (310) the credit server for the item. If (303) the item is not in inventory at the second vending machine, then the request is rejected (304), which causes the credit server to proceed to querying the next (312) closest vending machine to the first vending machine's location.

If the item is in inventory, then the item is reserved (305, 313), and held until the reservation time period expires (not shown), or until the credit token (code, social handle, email address, telephone number, face recognition, etc.) is received (306) by the second vending machine, either from the credit server or from the consumer depending on embodiment implementation options. The credit token is authenticated (307, 314), and if successful, the item is vended (308). When the item is detected as successfully dispensed, then the credit is deleted (315) from the credit database.

### Computer Program Product

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable media having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the logical processes shown and disclosed herein.

### Suitable Computing Platform

The preceding paragraphs have set forth example logical processes according to the present invention, which, when coupled with processing hardware, embody systems according to the present invention, and which, when coupled with tangible, computer readable memory devices, embody computer program products according to the related invention.

Regarding computers for executing the logical processes set forth herein, it will be readily recognized by those skilled in the art that a variety of computers are suitable and will become suitable as memory, processing, and communications capacities of computers and portable devices increase. In such embodiments, the operative invention includes the combination of the programmable computing platform and the programs together. In other embodiments, some or all of the logical processes may be committed to dedicated or specialized electronic circuitry, such as Application Specific Integrated Circuits or programmable logic devices.

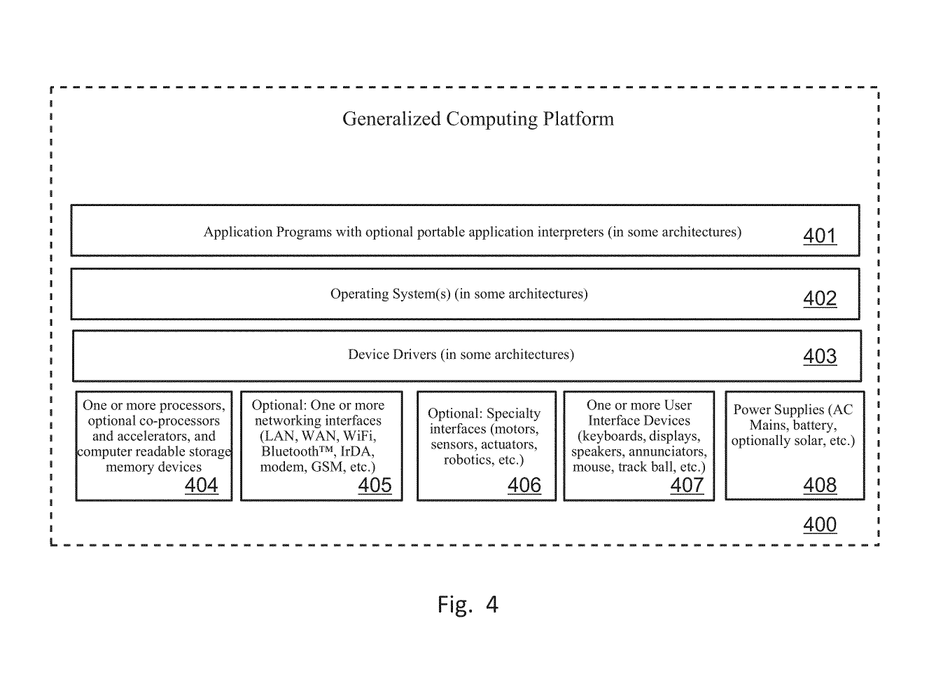

Embodiments may be realized for many different processors used in many different computing platforms. FIG. 4 illustrates a generalized computing platform (400), such as common and well-known computing platforms such as “Personal Computers”, web servers such as an IBM iSeries® server, and portable devices such as personal digital assistants and smart phones, running a popular operating systems (402) such as Microsoft® Windows® or IBM® AIX®, UNIX®, LINUX®, Google® Android®, Apple® iOS®, and others, may be employed to execute one or more application programs to accomplish the computerized methods described herein. Whereas these computing platforms and operating systems are well known and openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (401) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (404) sometimes accompanied by specialized co-processors or accelerators, such as graphics accelerators, and by suitable computer readable memory devices (RAM, ROM, disk drives, removable memory cards, etc.). Depending on the computing platform, one or more network interfaces (405) may be provided, as well as specialty interfaces for specific applications. If the computing platform is intended to interact with human users, it is provided with one or more user interface devices (407), such as display(s), keyboards, pointing devices, speakers, etc. Each computing platform requires one or more power supplies (battery, AC mains, solar, etc.).

### CONCLUSION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The descriptions of the disclosed embodiments have been presented for purposes of illustration, and they are not intended to be exhaustive or limited to the invention in the form(s) disclosed. Many modifications and variations will be apparent to those of ordinary skill in the art without departing from the scope and spirit of the invention. The disclosed embodiments were chosen and described in order to best explain the principles of the invention and the practical application, and to enable others of ordinary skill in the art to understand the invention for various embodiments with various modifications as are suited to the particular use contemplated.

It should also be recognized by those skilled in the art that certain embodiments utilizing a microprocessor executing a logical process may also be realized through customized electronic circuitry performing the same logical process or processes.

It will be readily recognized by those skilled in the art that the foregoing example embodiments do not define the extent or scope of the available embodiments, but instead are provided as illustrations of how to make and use the several embodiments. The following claims define the extent and scope of at least one invention disclosed herein.

1. A method of providing a vending machine fail-over comprising the steps of:
receiving by a server from an initial vending machine a request to find a fail-over vending machine to vend an item to a user for a credit value;
searching by the server for a first candidate vending machine in proximity to the initial vending machine;
responsive to finding a first candidate vending machine, determining by a computer if the item is in inventory at the first candidate vending machine;
responsive to determining the item is in inventory, selecting the first candidate fail-over vending machine as a fail-over vending machine;
generating by the server a first credit token and a second credit token;
storing the second credit token in an account associated with the user;
transmitting from the server to the fail-over vending machine the first credit token to enable vending of the item from the fail-over vending machine; and
notifying by the server the user of the availability of the item at the first candidate vending machine, of the transferred credit via the first credit token, and of the second credit token stored to the user's account.

2. The method as set forth in claim 1 wherein the determining if the item is in inventory is performed by the server.

3. The method as set forth in claim 1 wherein the determining if the item is in inventory is performed by the first candidate vending machine.

4. The method as set forth in claim 1 further comprising, responsive to determining if the item is in inventory results in no available inventory, repeating the steps of searching and determining for additional candidate vending machines.

5. The method as set forth in claim 1 wherein the second credit token comprises at least one credit token selected from the group consisting of a free credit for an item, a future bargain offer, and a coupon.

6. The method as set forth in claim 1 wherein the second credit token is associated with a unique identifier for a user account to which the credit is due.

7. The method as set forth in claim 6 wherein the unique identifier for a user account to which the credit is due comprises at least one unique identifier selected from the group consisting of an email address, a social network handle, a cellular telephone number, a user-supplied value, and a face recognition profile.

8. A computer program product for providing a vending machine fail-over comprising:
a computer-readable, tangible computer storage device; and
program instructions stored by the computer-readable, tangible computer storage device for causing a processor to perform steps of:
receiving by a server from an initial vending machine a request to find a fail-over vending machine to vend an item to a user for a credit value;
searching by the server for a first candidate vending machine in proximity to the initial vending machine;
responsive to finding a first candidate vending machine, determining by a computer if the item is in inventory at the first candidate vending machine;
responsive to determining the item is in inventory, selecting the first candidate fail-over vending machine as a fail-over vending machine;
generating by the server a first credit token and a second credit token;
storing the second credit token in an account associated with the user;
transmitting from the server to the fail-over vending machine the first credit token to enable vending of the item from the fail-over vending machine; and
notifying by the server the user of the availability of the item at the first candidate vending machine, of the transferred credit via the first credit token, and of the second credit token stored to the user's account.

9. The computer program product as set forth in claim 8 wherein the program instructions for determining if the item is in inventory are for causing the server to determine if the item is in inventory at the first candidate vending machine.

10. The computer program product as set forth in claim 8 wherein the program instructions for determining if the item is in inventory are for causing the first candidate vending machine to determine if the item is in inventory at the first candidate vending machine.

11. The computer program product as set forth in claim 8 wherein the program instructions further comprise instructions, responsive to determining if the item is in inventory results in no available inventory, to repeat the steps of searching and determining for additional candidate vending machines.

12. The computer program product as set forth in claim 8 wherein the second credit token comprises one or more tokens selected from the group consisting of a free credit for an item, a future bargain offer, and a coupon.

13. The computer program product as set forth in claim 8 wherein the second credit token is associated with a unique identifier for a user account to which the credit is due.

14. The computer program product as set forth in claim 13 wherein the unique identifier for a user account to which the credit is due comprises at least one unique identifier selected from the group consisting of an email address, a social network handle, a cellular telephone number, a user-supplied value, and a face recognition profile.

15. A system for providing a vending machine fail-over comprising:
at least one processor for performing steps according to program instructions;
a computer-readable, tangible computer storage device; and
program instructions stored by the computer-readable, tangible computer storage device for causing the at least one processor to perform steps of:
receiving by a server from an initial vending machine a request to find a fail-over vending machine to vend an item to a user for a credit value;
searching by the server for a first candidate vending machine in proximity to the initial vending machine;
responsive to finding a first candidate vending machine, determining by a computer if the item is in inventory at the first candidate vending machine;
responsive to determining the item is in inventory, selecting the first candidate fail-over vending machine as a fail-over vending machine;
generating by the server a first credit token and a second credit token;
storing the second credit token in an account associated with the user;
transmitting from the server to the fail-over vending machine the first credit token to enable vending of the item from the fail-over vending machine; and
notifying by the server the user of the availability of the item at the first candidate vending machine, of the transferred credit via the first credit token, and of the second credit token stored to the user's account.

16. The system as set forth in claim 15 wherein the program instructions for determining if the item is in inventory comprise program instructions selected from the group consisting of program instructions for the server, program instructions for the first candidate vending machine, and program instructions for both the server and the first candidate vending machine.

17. The system as set forth in claim 15 wherein the program instructions further comprise instructions, responsive to determining if the item is in inventory results in no available inventory, to repeat the steps of searching and determining for additional candidate vending machines.

18. The system as set forth in claim 15 wherein the second credit token comprises one or more tokens selected from the group consisting of free credit for an item, a future bargain offer, and a coupon.

19. The system as set forth in claim 15 wherein the second credit token is associated with a unique identifier for a user account to which the credit is due.

20. The system as set forth in claim 19 wherein the unique identifier for a user account to which the credit is due comprises at least one unique identifier selected from the group consisting of an email address, a social network handle, a cellular telephone number, a user-supplied value, and a face recognition profile.
